(19) United States
(12) Patent Application Publication
(10) Pub. No.: US 2022/0063812 A1
(43) Pub. Date: Mar. 3, 2022

(54) PROTECTIVE SHIELD SYSTEM FOR PUBLIC TRANSPORTATION

(71) Applicant: Tia A. Ryan, Philadelphia, PA (US)

(72) Inventor: Tia A. Ryan, Philadelphia, PA (US)

(21) Appl. No.: 17/463,599

(22) Filed: Sep. 1, 2021

Related U.S. Application Data
(60) Provisional application No. 63/073,999, filed on Sep. 3, 2020.

(51) Int. Cl. B64D 11/06

(52) U.S. Cl. CPC B64D 11/0606

(57) ABSTRACT

Exemplary embodiments are directed to a protective shield system. The protective shield system includes a base including a slot extending into an at least partially hollow interior of the base, a shield selectively extendable and retractable from the at least partially hollow interior of the base, an actuation mechanism to selectively extend and retract the shield from the at least partially hollow interior of the base.

### CROSS-REFERENCE TO RELATED APPLICATIONS

This application claims the benefit of co-pending U.S. Provisional Patent Application No. 63/073,999, which was filed on Sep. 3, 2020. The entire content of the foregoing provisional application is incorporated herein by reference.

### TECHNICAL FIELD

The present disclosure relates to a protective shield system and, in particular, to a selectively extendable and retractable protective shield for public transportation.

### BACKGROUND

Cleanliness in public transportation has always been a concern, particularly in commercial airplanes. With minimal time in-between flights, airlines may struggle to properly clean each seating area. While in the airplane, the elbow rests are generally insufficient to provide the desired distance or separation between passengers. In addition, the ongoing outbreak of SARS-CoV-2 (severe acute respiratory syndrome coronavirus 2), more commonly known as COVID-19, has resulted in increased concerns of both the public and medical community of viral transmission between passengers during the flight.

Thus, a need exists for a system that provides selective physical separation between passengers to prevent or reduce viral transmission. These and other needs are addressed by the protective shield system of the present disclosure.

### SUMMARY

In accordance with embodiments of the present disclosure, an exemplary protective shield system is provided. The protective shield system includes a base including a slot extending into an at least partially hollow interior of the base. The protective shield system includes a shield selectively extendable and retractable from the at least partially hollow interior of the base. The protective shield system includes an actuation mechanism to selectively extend and retract the shield from the at least partially hollow interior of the base.

The base can include a front wall and a rear wall. In some embodiments, the actuation mechanism includes actuation buttons disposed at the front wall of the base. In some embodiments, the system includes an interface at a mobile user device capable of wirelessly controlling extension and retraction of the shield with the actuation mechanism. The slot extends between the front and rear walls of the base, and is configured to accommodate passage of the shield. In some embodiments, the shield can be fabricated from a transparent material. In some embodiments, the shield can be fabricated from laminated glass or PLEXIGLASS®.

In some embodiments, the shield can include a rear edge and a front edge, the front edge angled inwardly towards the rear edge to form an outwardly directed point at a front of the shield. The outwardly directed point can define a widest section of the shield as measured between the rear and front edges. In some embodiments, the shield can include a rear edge, a front edge, a proximal top edge extending at an upward angle from the rear edge towards the front edge, and a distal top edge extending at a downward angle from the proximal top edge towards the front edge. The upward angle of the proximal top edge and the downward angle of the proximal top edge can form an upwardly directed point at a top of the shield. The upwardly directed point can define a highest section of the shield as measured from a bottom edge.

The protective shield system can include an internal track disposed within the base. A rear edge of the shield can be configured to slide along the internal track. The protective shield system can include a track extending from the base. The track can provide support to the shield during extension and retraction of the shield from the base. In some embodiments, the track can include an elongated rear flange and a protrusion extending between top and bottom ends of the elongated rear flange. In such embodiments, the protrusion can include an elongated slot formed therein, the elongated slot configured to slidably receive an edge of the shield as the shield is extended or retracted from the base.

In accordance with embodiments of the present disclosure, an exemplary protective shield system for an airplane including a cabin with a floor and ceiling is provided. The protective shield system includes a first seat and a second seat disposed adjacent to each other on the floor of the cabin, and a protective shield assembly disposed between the first seat and the second seat. The protective shield assembly includes a base including a slot extending into an at least partially hollow interior of the base, a shield selectively extendable and retractable from the at least partially hollow interior of the base, and an actuation mechanism to selectively extend and retract the shield from the at least partially hollow interior of the base.

In some embodiments, the protective shield assembly can include a track extending from the base and disposed within a gap between the first and second seats. The track can provide support to the shield during extension and retraction of the shield from the base. In some embodiments, the protective shield system can include a separation panel coupled at one end to at least one of the first seat or second seat, and coupled at an opposing end to the ceiling of the cabin. The separation panel can be fabricated from an antimicrobial material. In some embodiments, the first and second seats form a row within the airplane, and the row is rotated by a non-perpendicular angle (e.g., about 5 degrees) relative to a central longitudinal axis of the cabin.

In accordance with embodiments of the present disclosure, an exemplary method of operating a protective shield is provided. The method includes providing a protective shield system including a base including a slot extending into an at least partially hollow interior of the base, a shield selectively extendable and retractable from the at least partially hollow interior of the base, and an actuation mechanism. The method includes actuating the actuation mechanism to selectively extend and retract the shield from the at least partially hollow interior of the base.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed protective shield system, reference is made to the accompanying figures, wherein:

FIG. 1 is a top view of an airplane including an exemplary protective shield system according to the present disclosure.

FIG. 2 is a perspective view of a section of cabin seats of an airplane including an exemplary protective shield system according to the present disclosure.

FIG. 3 is a front elevation view of a section of a cabin of an airplane including an exemplary protective shield system according to the present disclosure.

FIG. 4 is a side view of an exemplary protective shield system according to the present disclosure in a retracted position.

FIG. 5 is a side view of an exemplary protective shield system of FIG. 4 in a partially extended position.

FIG. 6 is a side view of an exemplary protective shield system of FIG. 4 in a fully extended position.

FIG. 7 is a side view of an exemplary protective shield system of FIG. 4 in a fully extended position.

FIG. 8 is a perspective view of an exemplary protective shield system of FIG. 4 in a retracted position.

FIG. 9 is a perspective view of an exemplary protective shield system of FIG. 4 in a partially extended position.

FIG. 10 is a perspective view of an exemplary protective shield system of FIG. 4 in a fully extended position.

FIG. 11 is a perspective view of a shield of an exemplary protective shield system of FIG. 4.

FIG. 12 is a perspective view of a track of an exemplary protective shield system of FIG. 4.

FIG. 13 is a perspective view of a section of cabin seats of an airplane including an exemplary protective shield system and separation panel according to the present disclosure.

FIG. 14 is a front elevation view of a section of a cabin of an airplane including an exemplary protective shield system and a separation panel according to the present disclosure.

FIG. 15 is a side view of an exemplary protective shield system and a separation panel according to the present disclosure.

FIG. 16 is a top view of an airplane including an exemplary protective shield system and angled seating according to the present disclosure.

FIG. 17 is a block diagram of an exemplary protective shield system according to the present disclosure.

FIG. 18 is a block diagram of an exemplary computing device for implementing the exemplary protective shield system according to the present disclosure.

FIG. 19 is a block diagram of an exemplary protective shield system environment according to the present disclosure.

### DESCRIPTION OF EXEMPLARY EMBODIMENTS

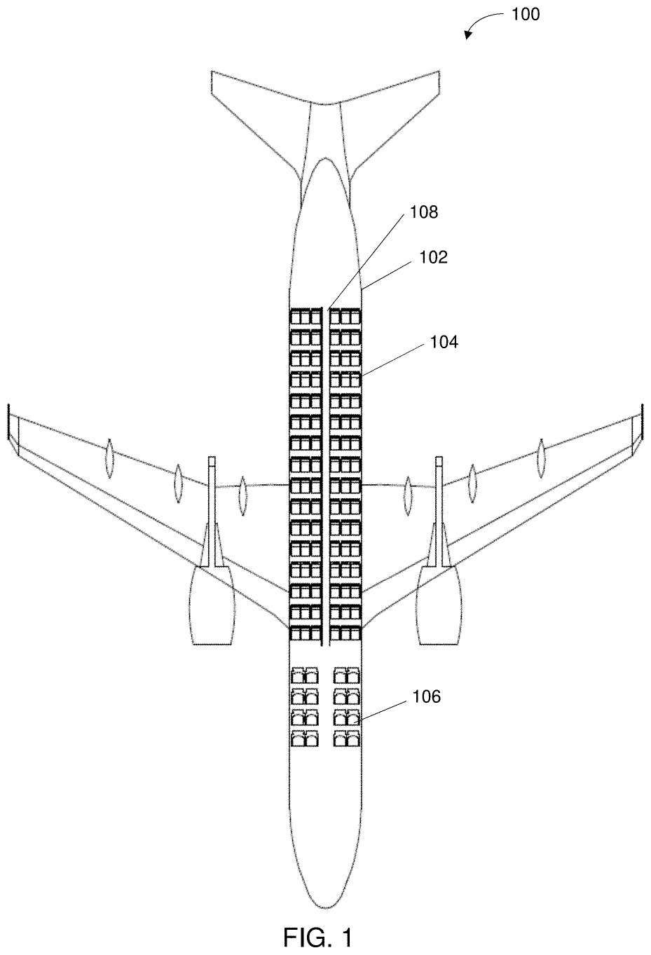

FIG. 1 is a top view of an airplane 100 that includes an exemplary protective shield system. Although discussed herein as being incorporated into the airplane 100, it should be understood that the protective shield system can be used in any type of public transportation, e.g., trains, buses, or the like. The airplane 100 includes a cabin 102 with multiple rows of seats 104, 106 separated by an aisle 108. The seats 104, 106 in each row are generally positioned close to each other, with passengers being positioned immediately adjacent to each other without means for preventing or reducing viral transmission throughout the cabin 102. The protective shield system allows for passengers to selectively raise or lower the protective shield, thereby reducing or preventing viral transmission between passengers, and increasing the confidence level of passengers.

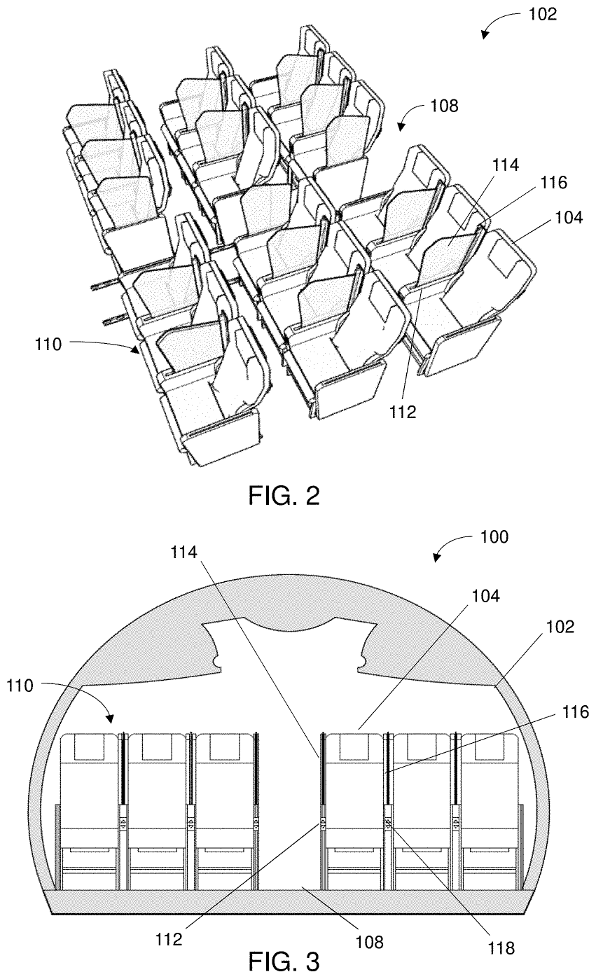

FIGS. 2 and 3 are perspective and front views of a section of the cabin 102 to illustrate how the exemplary protective shield system 110 (hereinafter “system 110”) can be incorporated into the airplane 100. The system 110 generally includes a base 112 that forms an armrest for the passenger. The system 100 includes a shield 114 that is capable of being selectively extended out of or retracted into the base 112, as desired by the passenger. In the retracted position, the shield 114 is disposed entirely within the base 112 (i.e., not extended beyond the top plane defined by the base 112), allowing the base 112 to be comfortably used as an armrest. In the extended position, the shield 114 at least partially extends above the top plane of the base 112, while still permitting the top surface of the base 112 adjacent to the shield 114 to be used as an armrest. The shield 114 can be fabricated from, e.g., laminated glass, PLEXIGLASS®, or the like. The shield 114 is transparent to maintain visibility within the cabin 102.

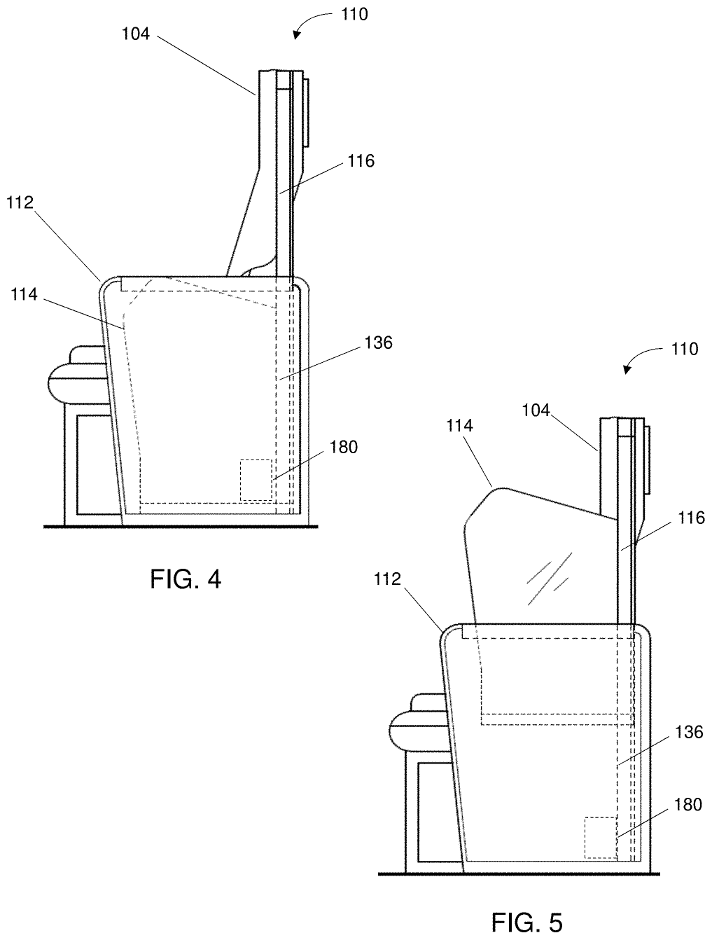

The system 110 includes a track 116 extending at one end of the base 112 and in-between the seats 104. The track 116 can provide support to the shield 114 as the shield 114 is extended our of or retracted into the base 112. For example, the track 116 can provide support on opposing sides of the shield 114 at the bottom and rear edges of the shield 114, while leaving the top and front edges of the shield 114 exposed. The track 116 can also act as an additional shield or blocking means to reduce passage of viral elements through the gap in-between the seats 104. The track 116 therefore substantially blocks the area between the seats 104 forming the gap. An actuation mechanism assembly can include up and down actuation buttons 118 positioned on the base 112 and electrically coupled to an internal mechanism 180 for driving extension and retraction of the shield 114 from the base 112 (see, e.g., FIGS. 4-6). In some embodiments, the internal mechanism 180 can be similar to the mechanism used for opening and closing a vehicle window (e.g., a mechanical/electrical lift system, a hydraulic electric lift system, or the like). The actuation buttons 118 can be used to regulate the extension height of the shield 114, thereby allowing for customized positioning of the shield 114.

Although illustrated as disposed between each of the seats 104 in each row and also at the end of each row on opposing sides of the aisle 108, in some embodiments, incorporation of the system 110 into the aisle seats 104 can be staggered. For example, an end seat 104 of one row can include the system 110 while the end seat 104 of the next row can be without the system 110. The seats 104 furthest from the aisle 108 do not have the system 110 between the seat 104 and the inner wall of the cabin 102.

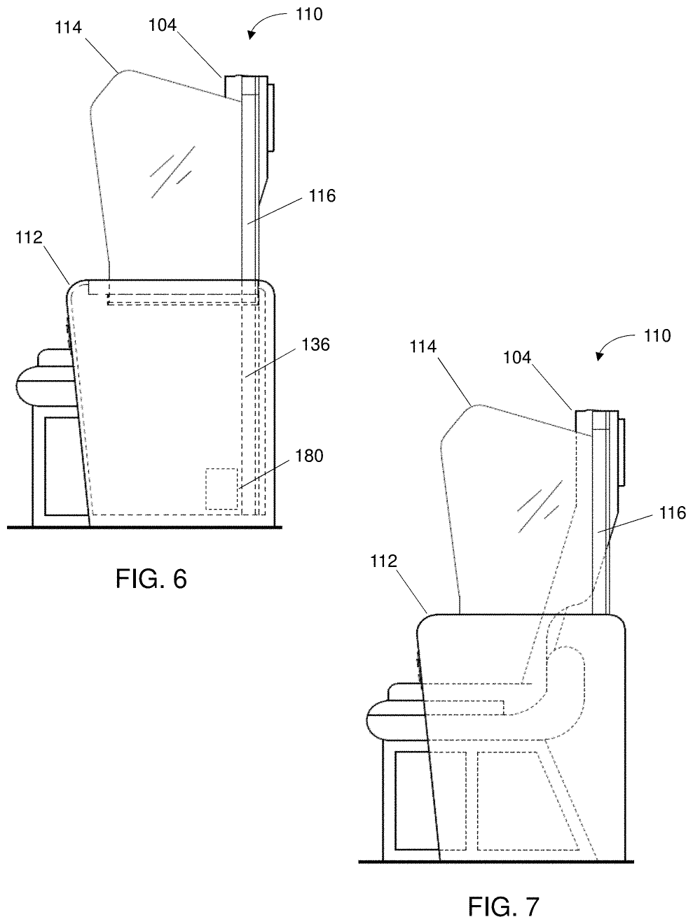

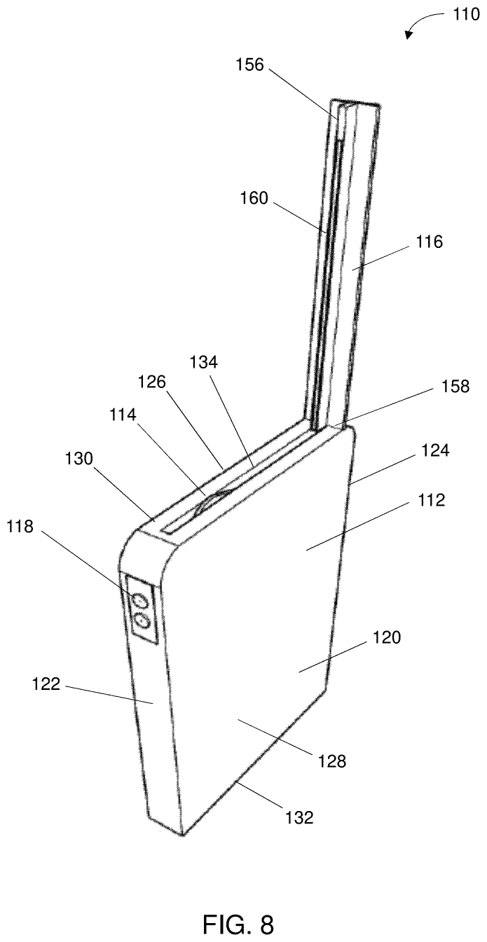

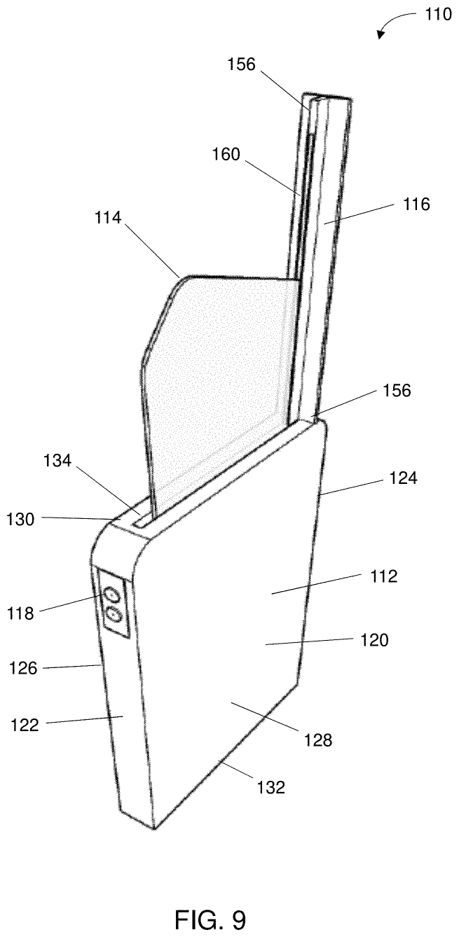

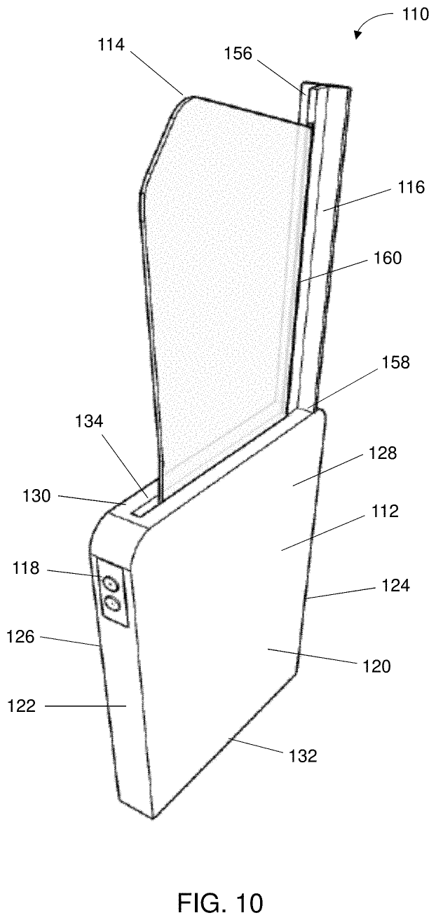

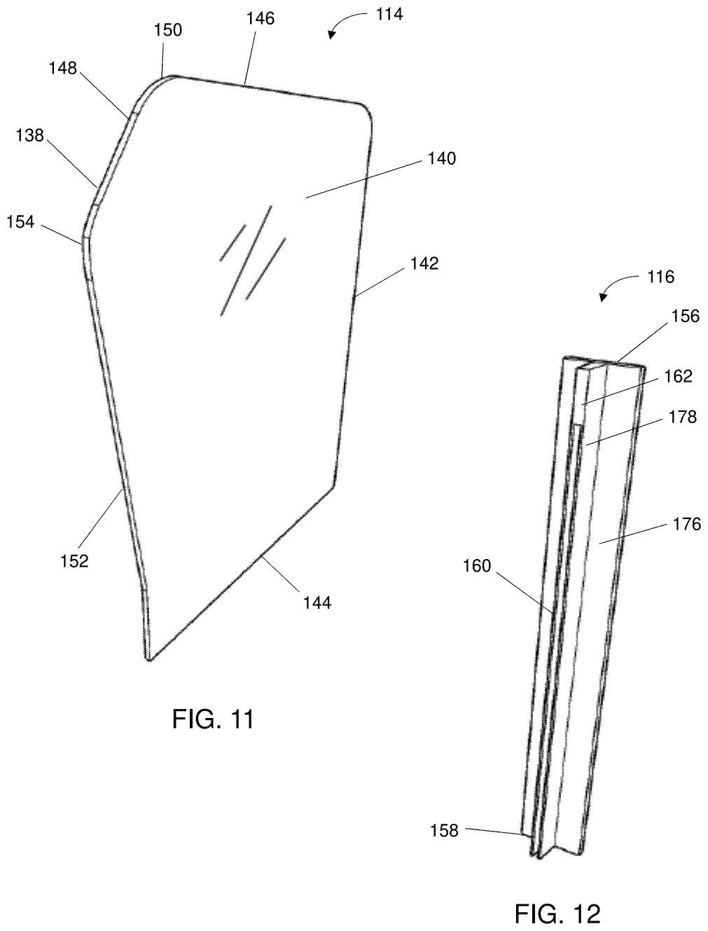

FIGS. 4-12 provide detailed views of the system 110, including different positions of the shield 114. In particular, FIGS. 4 and 8 are side and perspective views of the system 110 with the shield 114 in the retracted position, FIGS. 5 and 9 are side and perspective views of the system 110 with the shield 114 in a partially extended position, and FIGS. 6, 7 and 10 are side and perspective views of the system 110 with the shield 114 in a fully extended position. FIG. 11 is a perspective view of the shield 114, and FIG. 12 is a perspective view of the track 116.

In the retracted position, the shield 114 is entirely positioned within the base 112. As shown in FIGS. 8-10, the base 112 includes a substantially rectangular body 120 with a front wall 122, a rear wall 124, side walls 126, 128, a top wall 130, and a bottom wall 132. Each of the walls 122-132 can define a substantially planar configuration. In some embodiments, the front wall 122 can be angled inwardly towards the rear wall 124 as it extends downwardly towards the bottom wall 132 (e.g., in a configuration substantially complementary to the angles of the shield 114). In some embodiments, the bottom wall 132 can be positioned against and coupled to the floor of the cabin 102. In some embodiments, the actuation buttons 118 can be disposed on the front wall 122. For example, two actuation buttons for up and down operation can be disposed on the front wall 122 near the connecting corner between the front wall 122 and the top wall 130. In some embodiments, the actuation buttons 118 can be disposed on a lateral side wall 126, 128 of the base 112.

The top wall 130 includes an elongated slot 134 formed therein. The slot 134 can extend from a position at or near the front edge of the top wall 130 up to or near the rear edge of the top wall 130. The width of the slot 134 can be dimensioned to accommodate the width of the shield 114 for smooth extension and retraction of the shield 114 relative to the base 112. In some embodiments, the system 110 can include rubber covers or sheets on opposing sides of the shield 114 at the slot 134 to prevent infiltration of particles into the slot 134. When the shield 114 is in the retracted position, the rubber covers or sheets can completely cover the slot 134. In some embodiments, an additional cover element can be slid into position to cover the slot 134 when the shield 114 is in the retracted position, thereby providing a solid top surface for use as an armrest. The slot 134 can extend into an at least partially hollow interior of the base 112, with the interior of the base 112 capable of accommodating the entire shield 114. In some embodiments, as shown in FIGS. 4-6, the base 112 can include an internal track 136 extending along at least one inner surface (e.g., the rear wall 124). The internal track 136 can provide support to the rear edge of the shield 114 as the shield 114 is retracted into the base 114, thereby preventing damage to the shield 114 during use.

With reference to FIG. 11, the shield 114 generally includes planar, parallel side walls 138, 140, and a rear edge 142 that extends substantially perpendicularly relative to a bottom edge 144. In some embodiments, the thickness of the shield 114 as measured between the walls 138, 140 can be about, e.g., 0.125-0.5 inches inclusive, 0.125-0.4 inches inclusive, 0.125-0.3 inches inclusive, 0.125-0.2 inches inclusive, 0.125-0.15 inches inclusive, 0.15-0.5 inches inclusive, 0.2-0.5 inches inclusive, 0.3-0.5 inches inclusive, 0.4-0.5 inches inclusive, 0.125 inches, 0.15 inches, 0.2 inches, 0.3 inches, 0.4 inches, 0.5 inches, 0.25 inches, 0.375 inches, or the like.

The shield 114 includes a proximal top edge 146 (e.g., a rear facing top edge) that extends at an upwardly directed angle relative to the rear edge 142, and a distal top edge 148 (e.g., a front facing top edge) that extends at a downwardly directed angle relative to the proximal top edge 146. In some embodiments, the angle of the top edge 146 and/or the angle of the top edge 148 (as measured relative to a horizontal axis or plane) can be about, e.g., 90-120 degrees inclusive, 90-115 degrees inclusive, 90-110 degrees inclusive, 90-105 degrees inclusive, 90-100 degrees inclusive, 90-95 degrees inclusive, 95-120 degrees inclusive, 100-120 degrees inclusive, 105-120 degrees inclusive, 110-120 degrees inclusive, 115-120 degrees inclusive, 100-115 degrees, 105-115 degrees, 90 degrees, 95 degrees, 100 degrees, 105 degrees, 110 degrees, 115 degrees, 120 degrees, or the like. The length of the top edge 146 is dimensioned longer than the length of the top edge 148. The different angles of the top edges 146, 148 form a raised or upwardly directed curved point 150 in the shield 114 (e.g., the uppermost point of the shield 114). The raised curved point 150 is created to provide greater protection around the head of passengers when the shield 114 is fully extended from the base 112. In particular, the height and position of the raised curved point 150 relative to the bottom edge 144 is selected to substantially correspond with the position of the passenger's head, mouth and/or nose when the passenger is in the seated position, providing an area of greater separation between passengers at the top of the system 110 where viral particles may enter the airflow stream. In some embodiments, the height of the raised curved point 150 can correspond with the uppermost section of the seat 104.

Still with reference to FIG. 11, the shield 114 includes a front edge 152 on an opposing side from the rear edge 142. The front edge 152 extends towards the bottom edge 144 at an inwardly directed angle (e.g., an angle directed towards the rear edge 142). In some embodiments, the inwardly directed angle of the front edge 152 (as measured relative to a vertical axis or plane) can be about, e.g., 125-145 degrees inclusive, 125-140 degrees inclusive, 125-135 degrees inclusive, 125-130 degrees inclusive, 130-145 degrees inclusive, 135-145 degrees inclusive, 140-145 degrees inclusive, 130-140 degrees, 125 degrees, 130 degrees, 135 degrees, 136 degrees, 140 degrees, 145 degrees, or the like. The different angles of the top edge 148 and the front edge 152 form an outwardly directed curved point 154 that defines the frontmost section of the shield 114. The height and position of the curved point 154 is selected to substantially correspond with the position of the passenger's head, mouth and/or nose when the passenger is in the seated position, providing an area of greater separation between passengers at the front of the system 110 where viral particles may enter the airflow stream. In particular, the curved point 154 creates the widest section of the shield 114 to ensure protection between passengers is provided at head or face level. The inwardly directed angle of the front edge 152 also provides greater clearance for passengers to walk through the row in-between seats 104 without necessarily retracting the shield 114 into the base 112.

With reference to FIG. 12, the track 116 includes a body with an elongated rear flange 176. The flange 176 can define a substantially rectangular configuration. The track 116 includes a protrusion 178 extending perpendicularly from a central of the flange 176. The protrusion 178 can extend between the top and bottom ends 156, 158 of the flange 176. The track 116 includes an elongated, linear slot 160 formed in the protrusion 178 and extending into the protrusion 178. In some embodiments, the slot 160 can extend the full length of the protrusion 178 (e.g., between the top and bottom ends 156, 158 of the flange 176).

In some embodiments, the track 116 can include a dampening or stop member 162 at or near the top end 156 of the protrusion 178. For example, the member 162 can be a rubber member configured to provide a dampening effect to the shield 114 as the shield 114 is raised to the fully extended position. The slot 160 can extend through the bottom end 158 of the protrusion 178, thereby connecting the slot 160 with an aligned, substantially similar slot in the interior track 136 of the base 112. In particular, the bottom end 158 of the track 116 can be secured to the top wall 130 of the base 112 at or near the connection between the top and rear walls 130, 124. As the shield 114 is extended from the base 112, the rear edge 142 can slide along and within the slot 160 of the track 116. The track 116 provides structural support to the shield 114 as the shield 114 is extended and retracted from the base 112.

The passenger can therefore use the actuation buttons 118 to selectively raise, lower and adjust the position of the shield 114 along the track 116 to the desired height for separation between adjacent passengers. Such customized separation can assist in reducing or preventing viral transmission between passengers, and can assist in increasing the overall comfort and confidence level of passengers if they travel during periods of heightened sickness. In some embodiments, the system 110 can be detachable from the seat 104, allowing for removal of the system 110 from the plane 100. In some embodiments, the shield 114 can be detachable from the system 110 when use of the shield 114 is unnecessary.

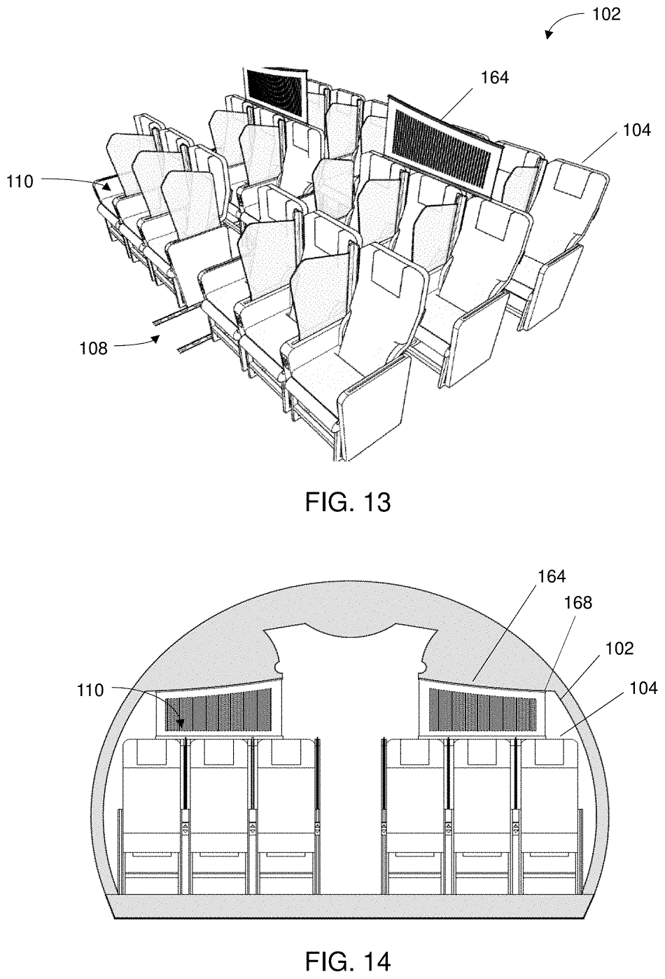

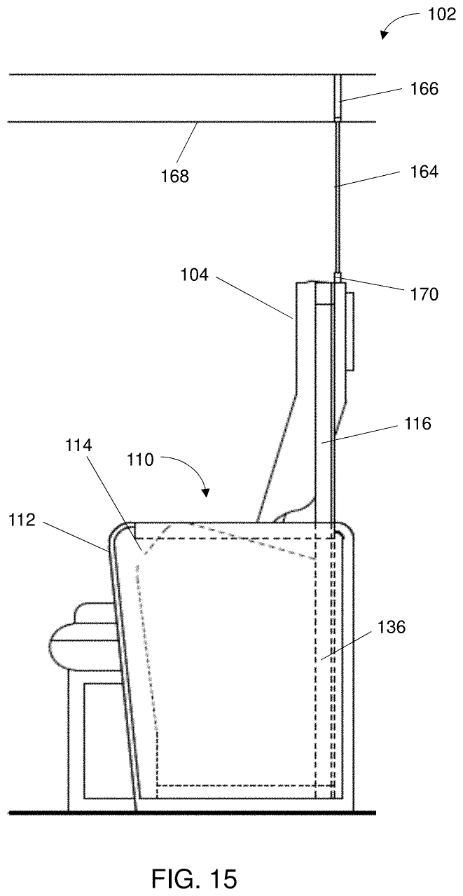

With reference to FIGS. 13-15, perspective, front and side views of a section of the cabin 102 are provided. In some embodiments, the cabin 102 can include one or more separation panels 164 disposed above the rows of seats 104 to provide additional separation between passengers. The panel 164 can include a fastener 166 (e.g., VELCRO®, hooks, or the like) at the top edge to detachably secure the panel 164 to the ceiling 168 of the cabin 102. In some embodiments, the bottom edge of the panel 164 can include a fastener 170 for detachably securing the panel 164 to the top of the seat(s) 104. In some embodiments, the top of the seat 104 can include a retraction mechanism allowing the panel 164 to be rolled into a storage housing. For use, the panel 164 can be pulled out and unrolled from the storage housing, and secured to the ceiling 168 with the fastener 166.

In some embodiments, the panels 164 can be positioned on opposing sides of the aisle 108. In some embodiments, the panels 164 can be positioned above each row of seats 104. In some embodiments, the panels 164 can be positioned every other row of seats 104. In some embodiments, the panels 164 can be positioned every three rows of seats 104. In some embodiments, the panels 164 can be staggered relative to each other on opposing sides of the aisle 108. Each panel 164 can be fabricated from a fabric material (e.g., cotton, or the like) to provide at least some visual and/or physical separation between the passengers. In some embodiments, each panel 164 can be fabricated from an antimicrobial material to assist in reducing viral particle transmission between passengers.

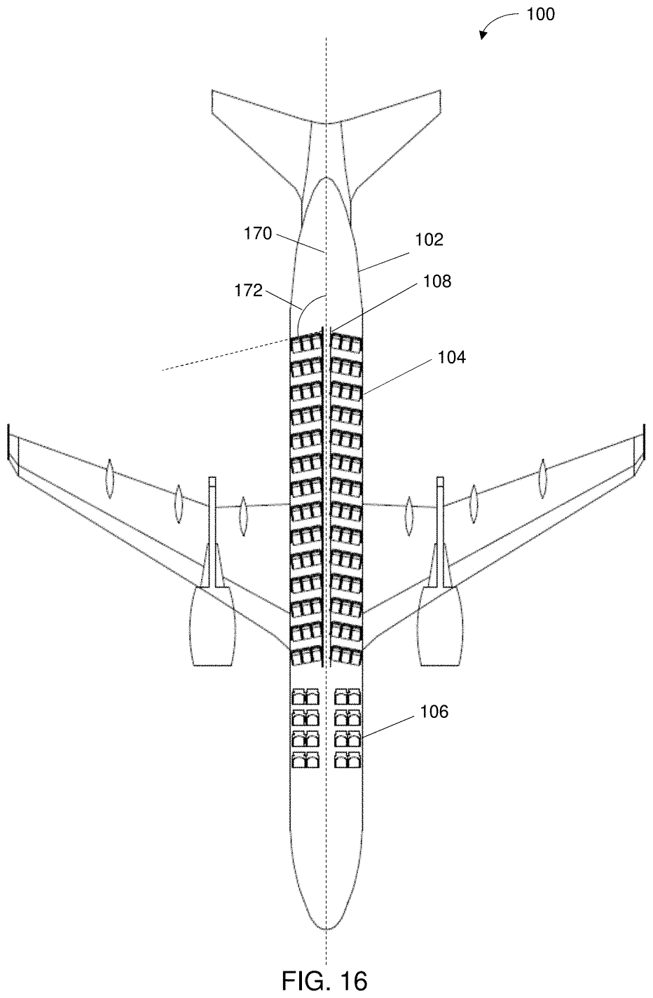

FIG. 16 is a top view of the airplane 100. In some embodiments, rather than rows of seats 104 that are oriented substantially perpendicularly relative to a central axis 170 of the cabin 102, the seats 104 can be rotated by an angle 172 on opposing sides of the axis 170. In some embodiments, the angle 172 can be about, e.g., 5-10 degrees inclusive, 5-9 degrees inclusive, 5-8 degrees inclusive, 5-7 degrees inclusive, 5-6 degrees inclusive, 6-10 degrees inclusive, 7-10 degrees inclusive, 8-10 degrees inclusive, 9-10 degrees inclusive, 5 degrees, 6 degrees, 7 degrees, 8 degrees, 9 degrees, 10 degrees, or the like. In some embodiments, the row of seats 104 on the left side of the aisle 108 can be rotated by about 5 degrees, and the row of seats 104 on the right side of the aisle 108 can be rotated by about 5 degrees. The angled position of the seats 104 on either side of the aisle 108 can provide additional room between the seats 104 in the aisle 108 for more convenient movement of passengers along the aisle 108.

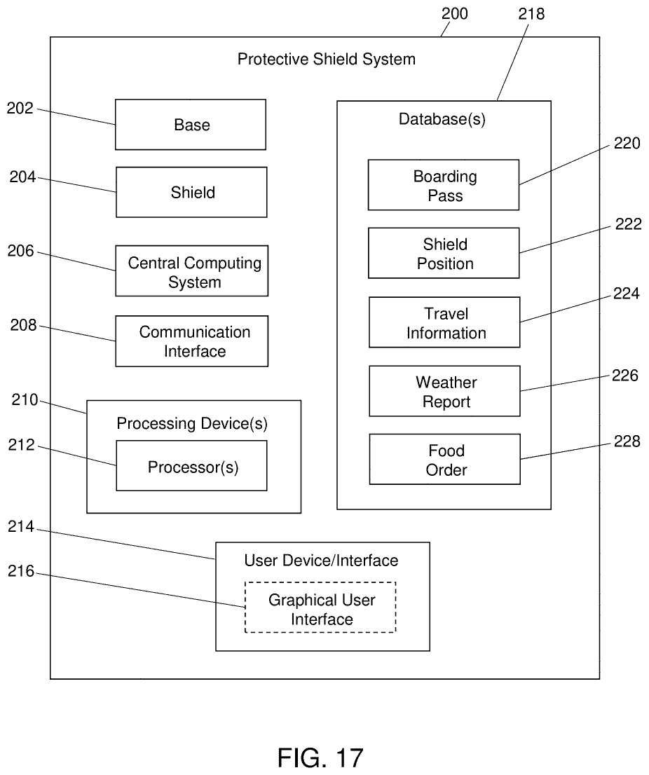

With reference to FIG. 17, a block diagram of an exemplary protective shield system 200 is provided. The system 200 includes a protective shield having a base 202 and a selectively retractable shield 204, as discussed herein. In some embodiments, in addition to controlling the extension and retraction of the shield 204 using the actuation mechanism buttons provided on the base 202, the system 200 can allow for control of the shield 204 position using a downloadable application. For example, the passenger can download an airline-specific application that allows for individual control of the shield 204 position during a specific flight.

The system 200 can include a central computing system 206 for analysis and processing of data. A processing device 210 with one or more processors 212 can be incorporated into the computing system 206 or can be separate from the computing system 206, and assists with processing data and/or commands input into the system 200. A communication interface 208 allows for electronic and/or wireless communication between a user device 214 (e.g., a smart mobile device, or the like) having a graphical user interface 216, the computing system 206, the processing device 210, the shield 204, and the database 218. The database 218 can electronically receive and store information relating to boarding passes 220 of passengers (such as the names and seats for each of the passengers), the shield position 222 (shield 204 relative to the base 202), travel information 224 (e.g., flight updates from a pilot or airline, updates from train operators, travel patterns, delays, or the like), weather reports 226, food orders 228 (e.g., ability to order food or beverages during flight, hospitality service assistance requests, or the like), or the like.

In use, the passenger can download the software application prior to boarding the flight. Upon boarding, the passenger can use the graphical user interface 216 (e.g., camera) to capture an image of the boarding pass to synchronize the application with the seat location. The system 200 can check the captured boarding pass image with the boarding pass 220 information to ensure the proper passenger is requesting access to control of the shield 204. Upon confirmation of a match, the system 200 provides for control of the shield 204 position using the graphical user interface 216. For example, the graphical user interface 216 can provide up and down electronic buttons for regulating the position of the shield 204, and can provide a value indicative of how far the shield 204 has been retracted and/or extended. Actuating the buttons in the user interface 216 can regulate the internal mechanism 180 to retract or extend the shield 204. Such control of the shield 204 position can reduce the number of surfaces the passenger needs to come in contact with, and can simplify operation of the shield 204. The passenger can have the option of also using the manual controls at the base 202 to operate the shield 204. The system 200 can therefore provide convenient means for controlling operation of the shield 204, while simultaneously providing an interface to communicate additional information to the passenger (e.g., regarding the flight) and allowing the passenger to use the application to communicate with the service attendants (e.g., regarding food or beverage orders).

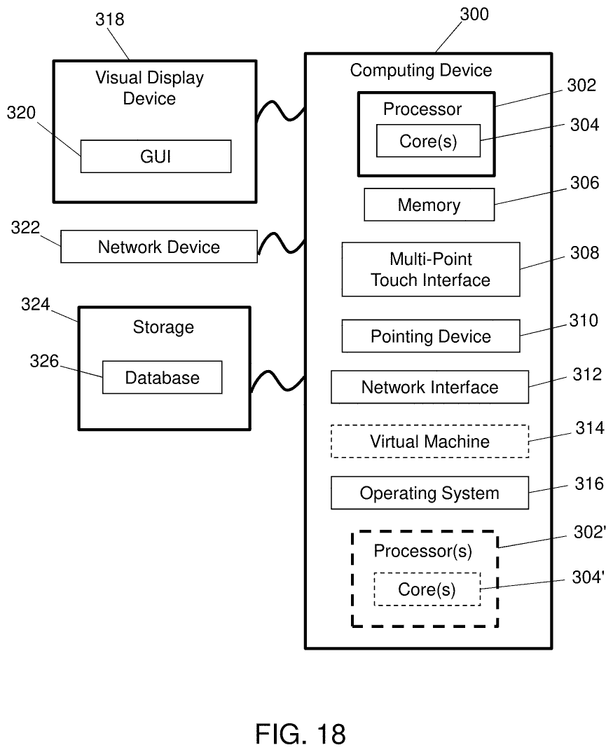

FIG. 18 is a block diagram of a computing device 300 in accordance with exemplary embodiments of the present disclosure. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions or software for implementing exemplary embodiments of the present disclosure (e.g., instructions for operating the processing device, instructions for operating the communication interface, instructions for operating the user interface, instructions for operating the central computing system, combinations thereof, or the like). The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device 300 may be shared dynamically. A virtual machine 314 may be provided to handle a process running on multiple processors so that the process appears to be using only one computing resource rather than multiple computing resources. Multiple virtual machines may also be used with one processor. Memory 306 may include a computer system memory or random access memory, such as DRAM, SRAM, EDO RAM, and the like. Memory 306 may include other types of memory as well, or combinations thereof.

A user may interact with the computing device 300 through a visual display device 318 (e.g., a mobile smart device, or the like), which may display at least one user interface 320 (e.g., a graphical user interface) that may be provided in accordance with exemplary embodiments. The computing device 300 may include other I/O devices for receiving input from a user, for example, a camera, an electronic keyboard, a microphone, or any suitable multi-point touch interface 308, or a pointing device 310. The interface 308 and the pointing device 310 may be coupled to the visual display device 318. The computing device 300 may include other suitable conventional I/O peripherals.

The computing device 300 may also include at least one storage device 324, such as a hard-drive, CD-ROM, eMMC (MultiMediaCard), SD (secure digital) card, flash drive, non-volatile storage media, or other computer readable media, for storing data and computer-readable instructions and/or software that implement exemplary embodiments of the protective shield systems described herein. Exemplary storage device 324 may also store at least one database 326 for storing any suitable information required to implement exemplary embodiments. For example, exemplary storage device 324 can store at least one database 326 for storing information, such as data relating to boarding passes, shield positions, travel information, weather information, food/beverage information, combinations thereof, or the like, and computer-readable instructions and/or software that implement exemplary embodiments described herein. The databases 326 may be updated by manually or automatically at any suitable time to add, delete, and/or update one or more items in the databases.

The computing device 300 can include a network interface 312 configured to interface via at least one network device 322 with one or more networks, for example, a Local Area Network (LAN), a Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 may include a built-in network adapter, a network interface card, a PCMCIA network card, Pa CI/PCIe network adapter, an SD adapter, a Bluetooth adapter, a card bus network adapter, a wireless network adapter, a USB network adapter, a modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the tablet computer), mobile computing or communication device (e.g., the smart phone communication device), an embedded computing platform, or other form of computing or telecommunications device that is capable of communication and that has sufficient processor power and memory capacity to perform the operations described herein.

The computing device 300 may run any operating system 316, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 316 may be run in native mode or emulated mode. In an exemplary embodiment, the operating system 316 may be run on one or more cloud machine instances.

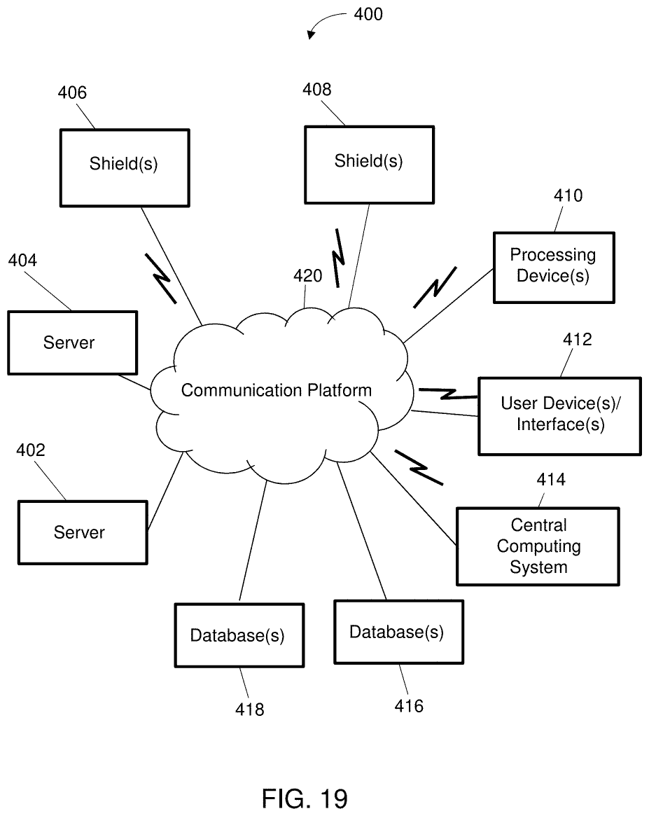

FIG. 19 is a block diagram of an exemplary protective shield system environment 400 in accordance with exemplary embodiments of the present disclosure. The environment 400 can include servers 402, 404 configured to be in communication with shields 406, 408, at least one processing device 410, user devices and/or interfaces 412, and at least one central computing system 414 via a communication platform 420, which can be any network over which information can be transmitted between devices communicatively coupled to the network. For example, the communication platform 420 can be the Internet, Intranet, virtual private network (VPN), wide area network (WAN), local area network (LAN), and the like. In some embodiments, the communication platform 420 can be part of a cloud environment.

The environment 400 can include repositories or databases 416, 418, which can be in communication with the shields 406, 408, at least one processing device 410, user devices and/or interfaces 412, and at least one central computing system 414, via the communications platform 620. In exemplary embodiments, the servers 402, 404, shields 406, 408, at least one processing device 410, user devices and/or interfaces 412, and at least one central computing system 414 can be implemented as computing devices (e.g., computing device 300). Those skilled in the art will recognize that the databases 416, 418 can be incorporated into at least one of the servers 402, 404. In some embodiments, the databases 416, 418 can store data relating to boarding passes, shield positions, flight information, weather reports, beverage/food, combinations thereof, or the like, and such data can be distributed over multiple databases 416, 418.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A protective shield system, comprising:
a base including a slot extending into an at least partially hollow interior of the base;
a shield selectively extendable and retractable from the at least partially hollow interior of the base; and
an actuation mechanism to selectively extend and retract the shield from the at least partially hollow interior of the base.

2. The protective shield system of claim 1, wherein the base includes a front wall and a rear wall.

3. The protective shield system of claim 2, wherein the actuation mechanism includes actuation buttons disposed at the front wall of the base.

4. The protective shield system of claim 2, wherein the slot extends between the front and rear walls of the base, and is configured to accommodate passage of the shield.

5. The protective shield system of claim 1, wherein the shield includes a rear edge and a front edge, the front edge angled inwardly towards the rear edge to form an outwardly directed point at a front of the shield.

6. The protective shield system of claim 5, wherein the outwardly directed point defines a widest section of the shield as measured between the rear and front edges.

7. The protective shield system of claim 1, wherein the shield includes a rear edge, a front edge, a proximal top edge extending at an upward angle from the rear edge towards the front edge, and a distal top edge extending at a downward angle from the proximal top edge towards the front edge.

8. The protective shield system of claim 7, wherein the upward angle of the proximal top edge and the downward angle of the proximal top edge form an upwardly directed point at a top of the shield.

9. The protective shield system of claim 8, wherein the upwardly directed point defines a highest section of the shield as measured from a bottom edge.

10. The protective shield system of claim 1, comprising an internal track disposed within the base, a rear edge of the shield configured to slide along the internal track.

11. The protective shield system of claim 1, comprising a track extending from the base, the track providing support to the shield during extension and retraction of the shield from the base.

12. The protective shield system of claim 11, wherein the track includes an elongated rear flange and a protrusion extending between top and bottom ends of the elongated rear flange.

13. The protective shield system of claim 12, wherein the protrusion includes an elongated slot formed therein, the elongated slot configured to slidably receive an edge of the shield as the shield is extended or retracted from the base.

14. The protective shield system of claim 1, comprising an interface at a mobile user device capable of wirelessly controlling extension and retraction of the shield with the actuation mechanism.

15. A protective shield system for an airplane including a cabin with a floor and ceiling, the protective shield system comprising:
a first seat and a second seat disposed adjacent to each other on the floor of the cabin; and
a protective shield assembly disposed between the first seat and the second seat, the protective shield assembly including:
a base including a slot extending into an at least partially hollow interior of the base;
a shield selectively extendable and retractable from the at least partially hollow interior of the base; and
an actuation mechanism to selectively extend and retract the shield from the at least partially hollow interior of the base.

16. The protective shield system of claim 16, comprising a track extending from the base and disposed within a gap between the first and second seats, the track providing support to the shield during extension and retraction of the shield from the base.

17. The protective shield system of claim 16, comprising a separation panel coupled at one end to at least one of the first seat or second seat, and coupled at an opposing end to the ceiling of the cabin.

18. The protective shield system of claim 18, wherein the separation panel is fabricated from an antimicrobial material.

19. The protective shield system of claim 16, wherein the first and second seats form a row within the airplane, and the row is rotated by a non-perpendicular angle relative to a central longitudinal axis of the cabin.

20. A method of operating a protective shield, comprising:
providing a protective shield system including (i) a base including a slot extending into an at least partially hollow interior of the base, (ii) a shield selectively extendable and retractable from the at least partially hollow interior of the base, and (iii) an actuation mechanism; and
actuating the actuation mechanism to selectively extend and retract the shield from the at least partially hollow interior of the base.
